(19) United States
(12) Patent Application Publication
(10) Pub. No.: US 2025/0367816 A1
(43) Pub. Date: Dec. 4, 2025

(54) DEVICE TO MOVE AN OBJECT AND METHOD TO USE THEREOF

(71) Applicant: Hartej Singh Anand, 2 Walk Up Circle, MA (US)

(72) Inventor: Hartej Singh Anand, 2 Walk Up Circle, MA (US)

(21) Appl. No.: 18/732,817

(22) Filed: Jun. 4, 2024

(51) Int. Cl. B25J 1/04

(52) U.S. Cl. CPC B25J 1/04

(57) ABSTRACT

Disclosed is a device to move an object. The device includes a panel; a handle; a holder; a connector; an opening slot; and a spring device. The handle is placed at a proximal end of the panel. The connector has a first end and a second end. The first end is attached to the handle and the second end is attached to the holder. The opening slot is defined at a distal end of the panel. The spring device is positioned within the opening slot and attached to the holder. The spring device is capable of being pulled back by the connector attached to the holder. The connector is configured to retract and release the spring device to trap and release the object.

### BACKGROUND

### Technical Field

The invention presented herein is generally directed toward a manual object mover device. More particularly, but not limited to, a device to move an object and a method for moving the object using the device.

### Description of the Related Art

As the global population ages, a growing number of elderly individuals face challenges with hand functionality and mobility. These difficulties can arise from various conditions such as arthritis, tremors, reduced muscle strength, and other age-related physical impairments. One significant problem is the inability to hold and move objects effectively, which impacts their ability to perform everyday tasks and activities. When individuals experience impairments with their hands, it can impact their ability to engage in daily activities and interact with others, including social interactions and quality time with family and friends.

Playing board games with family and friends offers not just the elderly but also those with physical and mobility issues a wonderful opportunity to engage in quality social interactions. These games not only provide entertainment but also serve as a means to combat feelings of loneliness and depression commonly experienced by seniors. However, as individuals age, they may find it increasingly challenging to participate in board games due to difficulties in manipulating game pieces across the board. This can be attributed to various factors, including hand disabilities that limit their ability to grasp and move pieces or physical limitations that hinder their ability to lean forward during gameplay.

The global population aged 60 and above is projected to double by the year 2050, leading to a corresponding increase in mobility challenges among the elderly. This increase in the elderly population will likely result in more cases where mobility issues can interfere with daily activities, independence, social interactions, and overall well-being. Mobility challenges can interfere with performing simple tasks whether that be moving small objects like a salt shaker across the table or playing board games with friends and family.

Recognizing the challenges faced by elderly individuals in participating fully in board games, this disclosure underscores the importance of developing a device for moving pieces and objects. Such a device would enable elderly individuals to interact more independently and comfortably during gameplay, allowing them to enjoy quality time with loved ones without feeling like a burden or being relegated to the sidelines as mere spectators.

Thus, in view of the above, there is a long-felt need in the industry to address the aforementioned deficiencies and inadequacies.

The approaches described in this section are approaches that could be pursued, but these are not necessarily approaches that have been previously conceived or pursued. Therefore, unless otherwise indicated, it should not be assumed that any of the approaches described in this section qualify as prior art merely by virtue of their inclusion in this section.

### SUMMARY

A device to move an object and a method for moving an object using the device are provided, as shown in and/or described in connection with at least one of the figures.

One aspect of the present disclosure relates to a device to move an object. The device includes a panel; a handle; a holder; a connector; an opening slot; and a spring device. The handle is placed at a proximal end of the panel. The connector has a first end and a second end. The first end is attached to the handle and the second end is attached to the holder. The opening slot is defined at a distal end of the panel. The spring device is positioned within the opening slot and attached to the holder. The spring device is capable of being pulled back by the connector attached to the holder. The connector is configured to retract and release the spring device to trap and release the object.

In an aspect, the handle is configured to reach toward the object and enables a user to hold onto the object and move the object without disrupting other objects.

In an aspect, the holder is configured to support the object.

In an aspect, the opening slot has a dimension of about 1.5 inches.

In an aspect, the connector is configured to retract and release the object in an upright position at a desired location.

Examples of the connector include but are not limited to a string, an elastic, an electrical unit with a motor, and a scissor mechanism.

In an aspect, the panel is selected from one or more of a foldable panel, and a non-foldable panel.

In an aspect, the foldable panel measures 10-12 inches when folded but is not limited to this size.

In an aspect, the non-foldable panel has a length of 20-24 inches when unfolded, but not limited to this size.

Examples of the connector include but are not limited to a string, an elastic, an electrical unit with a motor, a spring, and a scissor mechanism.

Another aspect of the present disclosure relates to a method for moving an object using a device. The method includes a step of grasping a handle placed at a proximal end of a panel. The method includes a step of engaging the object with a holder. The method includes a step of connecting a first end of a connector to the handle and a second end of the connector to the holder. The method includes a step of positioning a spring device within an opening slot defined at a distal end of the panel, with the spring device attached to the holder. The method includes a step of pulling back the spring by manipulating the connector attached to the holder. The method includes a step of retracting the connector to compress the spring device and trap the object with the holder. The method includes a step of releasing the connector to decompress the spring device and release the object from the holder.

Accordingly, one advantage of the present invention is that it can assist a user such as an elder, a disabled person, or a person who might have limited upper body motion due to injury, surgery, accident, etc. to move board game pieces (like monopoly, chess, and other game pieces), without the users having to physically move, allowing them the freedom to independently play board games with family and friends.

Accordingly, another advantage of the present invention is its ability to facilitate the movement of small objects from one location to another. For instance, users can easily transport items such as a salt shaker across a table with ease, thanks to the functionality provided by the invention. This feature enhances the convenience and practicality of the device in various everyday scenarios.

Hence, the present invention's device is also suitable for individuals with disabilities who may face challenges in leaning forward to manipulate game pieces and move small objects. This device offers them the flexibility to use it on a short-term or long-term basis, depending on their specific needs. Such individuals can greatly benefit from this device, enabling them to actively participate in a wide range of board games with movable pieces, thereby fostering meaningful interactions with family and friends. For instance, this device facilitates elders in playing various board games alongside their grandchildren, enhancing intergenerational bonding and enjoyment. The device also enables individuals to perform simple tasks requiring the moving of small objects independently. Additionally, the device can be utilized for as long as necessary by individuals who may be recovering from surgery, accidents, or other physical limitations. This enables them to participate in activities despite their temporary or ongoing physical restrictions.

Other embodiments and advantages will become readily apparent to those skilled in the art upon viewing the drawings and reading the detailed description hereafter, all without departing from the scope of the disclosure. The drawings and detailed descriptions presented are to be regarded as illustrative in nature and not in any way as restrictive.

Other features of the example embodiments will be apparent from the drawings and from the detailed description that follows.

### BRIEF DESCRIPTION OF THE DRAWINGS

The accompanying drawings illustrate the embodiments of devices, methods, and other aspects of the disclosure. Any person with ordinary skills in the art will appreciate that the illustrated element boundaries (e.g., boxes, groups of boxes, or other shapes) in the figures represent an example of the boundaries. In some examples, one element may be designed as multiple elements, or multiple elements may be designed as one element. In some examples, an element shown as an internal component of one element may be implemented as an external component in another and vice versa. Furthermore, the elements may not be drawn to scale.

Various embodiments will hereinafter be described in accordance with the appended drawings, which are provided to illustrate, not limit, the scope, wherein similar designations denote similar elements, and in which:

FIG. 1 illustrates a perspective view of a device (100) to move an object (112), in accordance with one embodiment of the present invention.

FIG. 2 illustrates a close-up view of a trapping feature of the device, in accordance with one embodiment of the present invention.

FIG. 3 illustrates a side view of the device, in accordance with one embodiment of the present invention.

FIG. 4 illustrates the device being used by pulling the string back, in accordance with one embodiment of the present invention.

FIG. 5 illustrates a flowchart of a method for moving an object using a device, in accordance with one embodiment of the present invention.

### DETAILED DESCRIPTION

The present description is best understood with reference to the detailed figures and description set forth herein. Various embodiments of the present system and method have been discussed with reference to the figures. However, those skilled in the art will readily appreciate that the detailed description provided herein with respect to the figures are merely for explanatory purposes, as the present system and method may extend beyond the described embodiments. For instance, the teachings presented and the needs of a particular application may yield multiple alternative and suitable approaches to implement the functionality of any detail of the present systems and methods described herein. Therefore, any approach to implement the present system and method may extend beyond certain implementation choices in the following embodiments.

According to an embodiment herein, the methods of the present invention may be implemented by performing or completing manually, automatically, and/or a combination of thereof. The term “method” refers to manners, means, techniques, and procedures for accomplishing any task including, but not limited to, those manners, means, techniques, and procedures either known to the person skilled in the art or readily developed from existing manners, means, techniques and procedures by practitioners of the art to which the present invention belongs. The persons skilled in the art will envision many other possible variations within the scope of the present system and method described herein.

At a high level, aspects of the present disclosure are directed to a device designed to securely grasp board game pieces, it's also designed to cater to individuals with disabilities who may struggle to lean forward to manipulate game pieces. This device provides them with adaptable usage options, whether for short-term or long-term needs. This inclusivity allows individuals facing such challenges to fully engage in a diverse array of board games featuring movable pieces, thus nurturing meaningful connections with loved ones. For example, this device could have facilitated elderly individuals in actively participating in various board games alongside their grandchildren, thereby fostering intergenerational bonding and enhancing overall enjoyment.

The inability to hold and move objects efficiently has a profound impact on the daily lives of elderly individuals. It restricts their independence, making them reliant on others even for simple acts like reaching across a table. Furthermore, this loss of autonomy can lead to feelings of frustration, helplessness, and decreased self-esteem. The cumulative effect of these challenges significantly diminishes their overall quality of life and well-being.

Given these substantial difficulties, there is a pressing need for innovative solutions that can assist elderly individuals in managing their hand functionality and mobility issues. The development of devices and methods that cater to their specific needs can greatly enhance their ability to perform daily tasks independently and improve their quality of life.

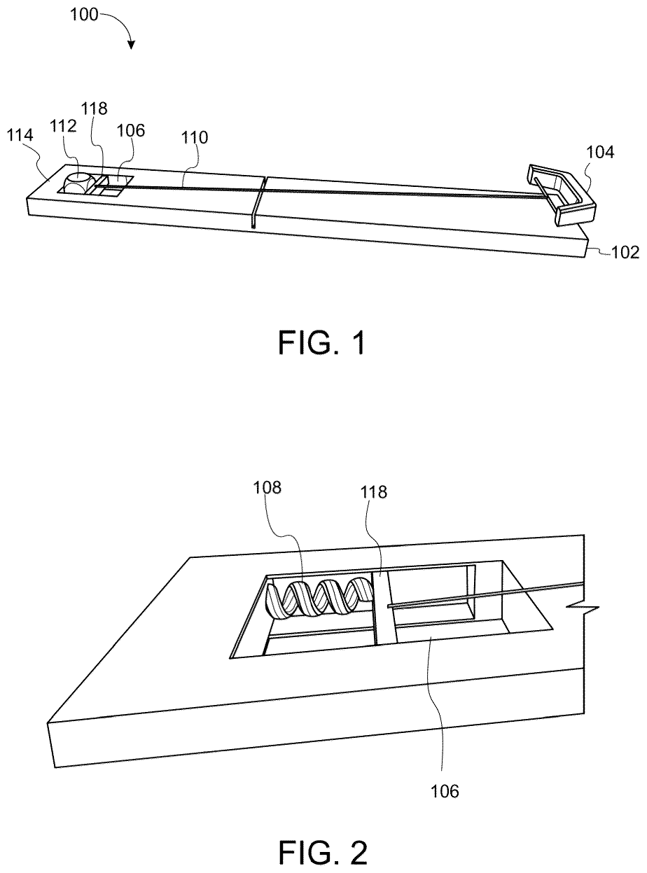

FIG. 1 illustrates a perspective view of a device 100 to move an object 112, in accordance with one embodiment of the present invention. The device 100 includes a panel 102; a handle 104; a holder 118; a connector 110; an opening slot 104; and a spring device 108 (shown in FIG. 2). The handle 104 is placed at a proximal end of the panel 102. The connector 110 has a first end and a second end. The first end is attached to the handle 104 and the second end is attached to the holder 118. The opening slot 104 is defined at a distal end of the panel 102.

FIG. 2 illustrates a close-up view of a trapping feature of the device, in accordance with one embodiment of the present invention. FIG. 2 is explained in conjunction with FIG. 1. The spring device 108 is positioned within the opening slot 104 and attached to the holder 118. The spring device 108 is capable of being pulled back by the connector 110 attached to the holder 118. The connector 110 is configured to retract and release the spring device 108 to trap and release the object 112.

In an embodiment, the handle 104 is configured to reach toward the object 112 and enables a user to hold onto the object 112 and move the object 112 without disrupting other objects. In an embodiment, the holder 118 is configured to support the object 112. In an embodiment, the spring device 108 can encompass other types of spring devices that exert force against each other, or elastic materials that provide similar spring-like properties.

In an embodiment, the opening slot 104 has a dimension of about 1.5 inches. In an embodiment, the connector 110 is configured to retract and release the object in an upright position at a desired location. In an embodiment, the connector 110 is selected from one or more of: a string, an elastic, an electrical unit with a motor, and a scissor mechanism. Examples of the connector 110 include but are not limited to a string, an elastic, an electrical unit with a motor, a spring, and a scissor mechanism.

In an embodiment, the panel 102 is selected from one or more of: a foldable panel, and a non-foldable panel. In an embodiment, the foldable panel measures 10-12 inches when folded but is not limited to this size. In an embodiment, the non-foldable panel 102 typically measures between 20 to 24 inches in length, providing ample coverage for various applications. In contrast, the foldable panel offers a more compact solution, with a length ranging from 10 to 12 inches. This versatility allows users to select the panel type that best suits their specific needs, whether they prioritize portability or extended coverage.

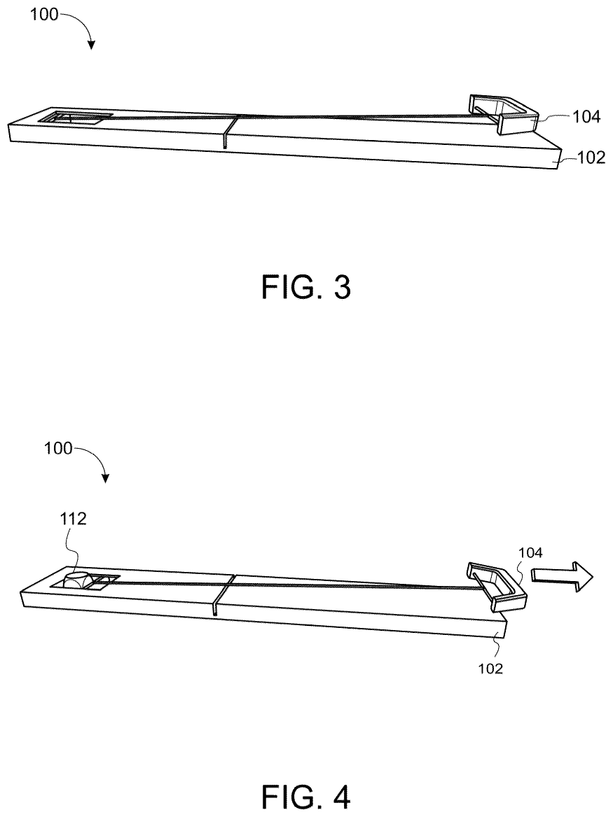

FIG. 3 illustrates a side view of the device, in accordance with one embodiment of the present invention. The device 100 may be available in both foldable and non-foldable designs. The foldable variant allows for convenient storage and can be shipped alongside the original game, offering ease of transport. Meanwhile, the non-foldable version maintains the functionality of the device without compromise. The non-foldable model measures approximately 22 inches in length with a 1.5-inch opening, while the foldable variant is half the length but features the same opening size.

FIG. 4 illustrates the device 100 being used by pulling the string back, in accordance with one embodiment of the present invention. In another embodiment, the device 100 may feature an elastic contraption in place of the spring mechanism. In an exemplary embodiment, the device enables a user to hold onto a game piece and move the game pieces around a game board without disrupting other game pieces.

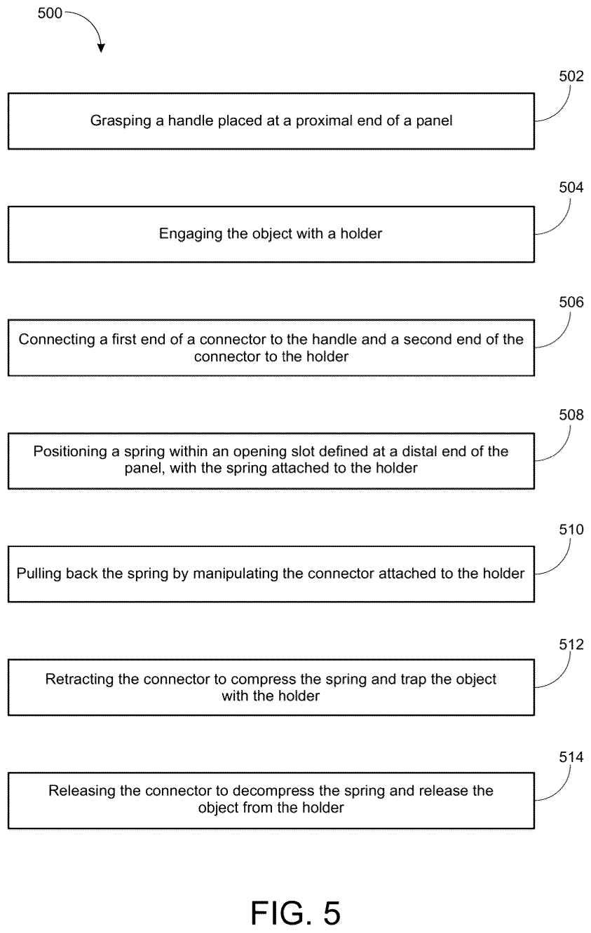

FIG. 5 illustrates a flowchart of a method 500 for moving an object using a device, in accordance with one embodiment of the present invention. The method 500 includes a step 502 of grasping a handle placed at a proximal end of a panel. The method 500 includes a step 504 of engaging the object with a holder. The method 500 includes a step 506 of connecting a first end of a connector to the handle and a second end of the connector to the holder. The method 500 includes a step 508 of positioning a spring device within an opening slot defined at a distal end of the panel, with the spring device attached to the holder. The method 500 includes a step 510 of pulling back the spring by manipulating the connector attached to the holder. The method 500 includes a step 512 of retracting the connector to compress the spring device and trap the object with the holder. The method 500 includes a step 514 of releasing the connector to decompress the spring device and release the object from the holder.

The device of the present invention is relatively straightforward to manufacture in bulk, as it does not necessitate any specialized technology or equipment. It is expected to be a budget-friendly option, priced at under $20, making it accessible to a wide range of users.

The present device alleviates many barriers faced by the aging population, which otherwise prevent or hinder them from enjoying board games with their family and friends.

Moreover, this invention facilitates elderly individuals and those with disabilities to engage in and relish board games and social interactions with family and friends. Additionally, for those who prefer solitary play, this device offers the convenience of moving pieces that are out of reach, enhancing their gaming experience.

Unless otherwise defined, all terms (including technical and scientific terms) used in this disclosure have the same meaning as commonly understood by one of ordinary skill in the art to which this disclosure belongs. It is to be understood that the phrases or terms employed of the present invention are for description and not of limitation. As will be appreciated by one of the skills in the art, the present disclosure may be embodied as a device, system, and method. The present systems and methods have been described above with reference to specific examples. However, other embodiments and examples than the above description are equally possible within the scope of the present invention. The scope of the disclosure may only be limited by the appended patent claims. Even though modifications and changes may be suggested by the persons skilled in the art, it is the intention of the inventors and applicants to embody within the patent warranted heron all the changes and modifications as reasonably and properly come within the scope of the contribution the inventors and applicants to the art. The scope of the embodiments of the present invention is ascertained with the claims to be submitted at the time of filing the complete specification.

What is claimed is:

1. A device to move an object, comprising:
a panel;
a handle placed at a proximal end of the panel;
a holder;
a connector with a first end attached to the handle; and a second end attached to the holder;
an opening slot defined at a distal end of the panel; and
a spring device positioned within the opening slot and attached to the holder, wherein the spring device is capable of being pulled back by the connector attached to the holder, wherein the connector is configured to retract and release the spring device to trap and release the object.

2. The device as claimed in claim 1, wherein the handle is configured to reach toward the object and enables a user to hold onto the object and move the object without disrupting other objects.

3. The device as claimed in claim 1, wherein the holder is configured to support the object.

4. The device as claimed in claim 1, wherein the opening slot has a dimension of about 1.5 inches.

5. The device as claimed in claim 1, wherein the connector is configured to retract and release the object in an upright position at a desired location.

6. The device as claimed in claim 1, wherein the connector is selected from one or more of: a string, an elastic, an electrical unit with a motor, and a scissor mechanism.

7. The device as claimed in claim 1, wherein the panel is selected from one or more of: a foldable panel, and a non-foldable panel.

8. A method for moving an object using a device, the method comprising:
grasping a handle placed at a proximal end of a panel;
engaging the object with a holder;
connecting a first end of a connector to the handle and a second end of the connector to the holder;
positioning a spring device within an opening slot defined at a distal end of the panel, with the spring device attached to the holder;
pulling back the spring by manipulating the connector attached to the holder;
retracting the connector to compress the spring device and trap the object with the holder; and
releasing the connector to decompress the spring device and release the object from the holder.
